(19) United States
(12) Patent Application Publication
(10) Pub. No.: US 2015/0176833 A1
(43) Pub. Date: Jun. 25, 2015

(54) Lamp and Air-Guiding Ring Thereof

(71) Applicant: Sunonwealth Electric Machine Industry Co., Ltd., Kaohsiung City (TW)

(72) Inventors: Alex Horng, Kaohsiung City (TW); Chien-Chih Chen, Kaohsiung City (TW)

(73) Assignee: Sunonwealth Electric Machine Industry Co., Ltd., Kaohsiung City (TW)

(21) Appl. No.: 14/230,079

(22) Filed: Mar. 31, 2014

(30) Foreign Application Priority Data
Dec. 19, 2013 (TW) 102147216
Mar. 4, 2014 (TW) 103107266

(51) Int. Cl. F21V 33/00; F21V 15/01

(52) U.S. Cl. CPC F21V 33/0088; F21V 15/01

(57) ABSTRACT

A lamp includes a lamp unit and an air-guiding ring. The lamp unit has a housing receiving a light-emitting element, as well as a fitted portion formed on an outer periphery of the housing. The air-guiding ring has an inner periphery forming a fitting hole and is fitted around the fitted portion of the lamp unit via the fitting hole. The air-guiding ring comprises a venting portion extending from an outer periphery to the inner periphery of the air-guiding ring. In another embodiment, the air-guiding ring is disclosed.

### BACKGROUND OF THE INVENTION

1. Field of the Invention

The present invention generally relates to a lamp and an air-guiding ring thereof, more particularly, to a lamp that can be used with a fan and fitted with an air-guiding ring in order to form a ventilation structure for the fan to provide a predetermined ventilation effect, as well as the air-guiding ring thereof.

2. Description of the Related Art

FIG. 1 shows a conventional lamp 7 disclosed by Taiwan Patent No. 200834019. Lamp 7 includes a lamp unit 71 and a fan housing 72. Fan housing 72 includes an air inlet 721 and an air outlet 722. An impeller 723 is installed in fan housing 72.

Lamp unit 71 and fan housing 72 may be mounted in a ceiling or a wall. An air pipe (not shown) may be connected to air outlet 722 of fan housing 72. In this arrangement, when impeller 723 rotates, impeller 723 draws air through lamp unit 71 and air inlet 721 and discharges the air via the air outlet 722 and the air pipe. As such, a desired ventilation effect can be achieved while the heat generated by lamp unit 71 is reduced.

However, said lamp 7 requires drilling a hole on the ceiling or wall for ventilation purposes of fan housing 72. Disadvantageously, it is inconvenient to install the lamp 7 into the ceiling or wall.

FIG. 2 shows another conventional lamp 8 with a discharging fan as disclosed by China Patent No. 200520064891.3. Said lamp 8 includes a cover 81 and a discharging fan 82. Cover 81 has a plurality of vents 811 and is coupled to a side of discharging fan 82. A chamber is formed between cover 81 and discharging fan 82. A light-emitting module (not shown) is received in the chamber. Cover 81 can be mounted in the ceiling or wall. As such, when discharging fan 82 rotates, air is guided into and out of said lamp 8 via the plurality of vents 811 to provide a desired ventilation effect.

However, cover 81 and discharging fan 82 must be assembled to each other so that discharging fan 82 is able to smoothly guide air into and out of lamp 8. In this regard, lamp 8 requires complex assembly procedures among the cover 81, the discharging fan 82 and an illumination device, leading to an inconvenient assembly of lamp 8.

FIG. 3 shows a further conventional lamp 9 with a discharging fan as disclosed by China Patent No. 94204173.9. Said lamp 9 includes a centrifugal fan 91 coupled with a cover 92. Cover 92 may be coupled with a fluorescent tube (not shown) capable of emitting light. Cover 92 includes a plurality of inlets 921. Therefore, when said lamp 9 is installed in a ceiling or a wall, centrifugal fan 91 is able to draw air into and out of the plurality of inlets 921 to provide a desired ventilation effect.

However, since the plurality of inlets 921 is arranged on the surface of cover 92 in order for centrifugal fan 91 to smoothly guide air into and out of said lamp 9, the structural strength of cover 92 tends to be lower. Another disadvantage is that cover 92 has to be designed in a way that enables cover 92 to be coupled with the fluorescent tube. Thus, manufacturing of said lamp 9 is inconvenient.

### SUMMARY OF THE INVENTION

It is therefore the objective of this invention to provide a lamp and an air-guiding ring thereof in which the air-guiding ring can be easily fitted around the lamp to effectively reduce the assembly complexity.

It is another objective of this invention to provide a lamp and an air-guiding ring thereof in which the air-guiding ring can be directly used with a fan to provide a predetermined ventilation effect without having to drill vents on the ceiling or wall.

It is a further objective of this invention to provide an air-guiding ring of a lamp that can be directly fitted around the lamp without having to change the structure of the lamp. Thus, a fan can be used with the air-guiding ring to provide a predetermined ventilation effect.

In an embodiment of the invention, a lamp comprising a lamp unit and an air-guiding ring is disclosed. The lamp unit has a housing receiving a light-emitting element, as well as a fitted portion formed on an outer periphery of the housing. The air-guiding ring has an inner periphery forming a fitting hole and is fitted around the fitted portion of the lamp unit via the fitting hole. The air-guiding ring comprises a venting portion extending from an outer periphery to the inner periphery of the air-guiding ring.

In a form shown, the venting portion is in the form of a plurality of openings, and a plurality of protrusions is formed on a face of the air-guiding ring. The protrusions are spaced from each other to form a respective opening between each two adjacent protrusions. The plurality of openings extends from the outer periphery to the inner periphery of the air-guiding ring.

In the form shown, the venting portion is in the form of a plurality of slits extending from the outer periphery to the inner periphery of the air-guiding ring.

In the form shown, the air-guiding ring is a ring with elastic expansion or shrinkage.

In the form shown, a plurality of positioning members is arranged on a face of the air-guiding ring.

In the form shown, each positioning member has an abutting face and a coupling face opposite to the abutting face, and the abutting face abuts with the fitted portion of the housing.

In the form shown, the abutting face is an arc-like face.

In the form shown, the lamp unit is coupled with a fan.

In the form shown, the housing comprises a decorative protrusion adjoining the fitted portion and covering the air-guiding ring.

In the form shown, an outer cover is arranged on the outer periphery of the air-guiding ring and coupled with the decorative protrusion of the housing.

In the form shown, at least one of the plurality of protrusions includes an abutting protrusion, the abutting protrusion is close to the inner periphery of the air-guiding ring than to the outer periphery of the air-guiding ring.

In the form shown, at least one of the plurality of protrusions includes a radial extension extending outwards from the outer periphery of the air-guiding ring in a radial direction.

In another embodiment of the invention, an air-guiding ring of a lamp is disclosed. The air-guiding ring has an inner periphery forming a fitting hole and a venting portion extending from an outer periphery to the inner periphery of the air-guiding ring.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an exploded view of a conventional lamp.

FIG. 2 shows another conventional lamp.

FIG. 3 is a perspective view of a further conventional lamp.

FIG. 4 is an exploded view of a lamp according to an embodiment of the invention.

FIG. 5 shows an air-guiding ring of the lamp of the embodiment of the invention.

FIG. 6 shows an air-guiding ring of the lamp according to another embodiment of the invention.

FIG. 7 shows an air-guiding ring of the lamp according to a further embodiment of the invention.

FIG. 8 is a cross sectional view of the lamp of the invention.

FIG. 9 is an exploded view of another type of lamp equipped with the air-guiding ring according to the invention.

FIG. 10 is a cross sectional view of the lamp in FIG. 9.

FIG. 11 shows an air-guiding ring having a plurality of protrusions according to a still further embodiment of the invention, with each protrusion comprising an abutting protrusion and a radial extension.

FIG. 12 is a cross-sectional view of a lamp equipped with the air-guiding ring of FIG. 11.

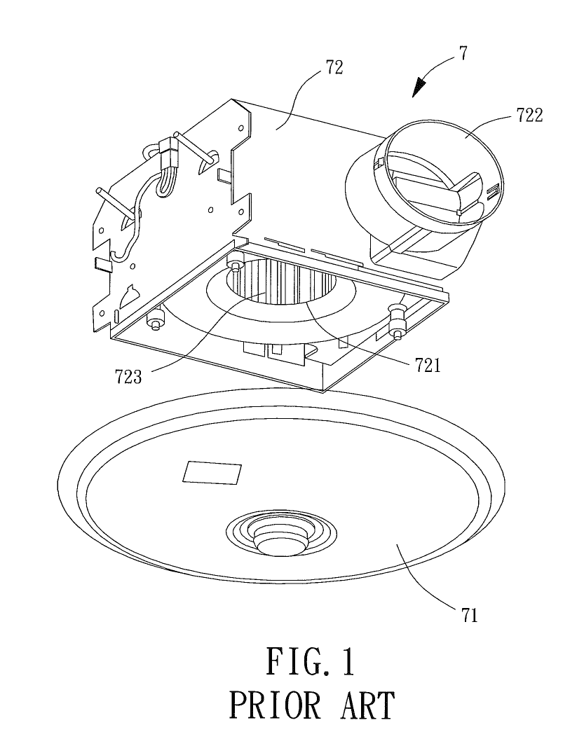

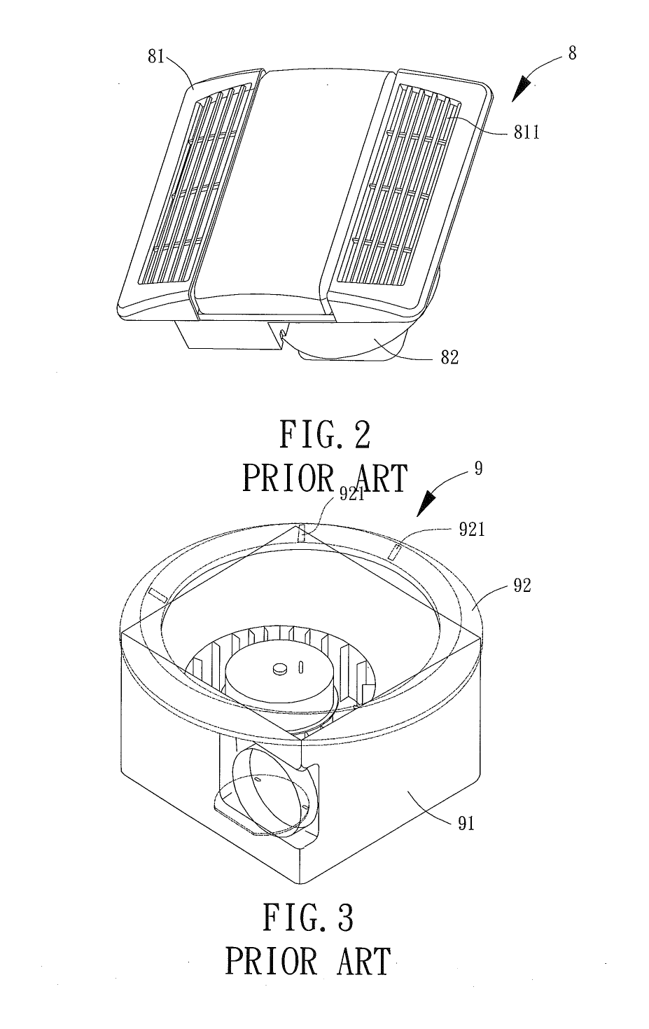

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

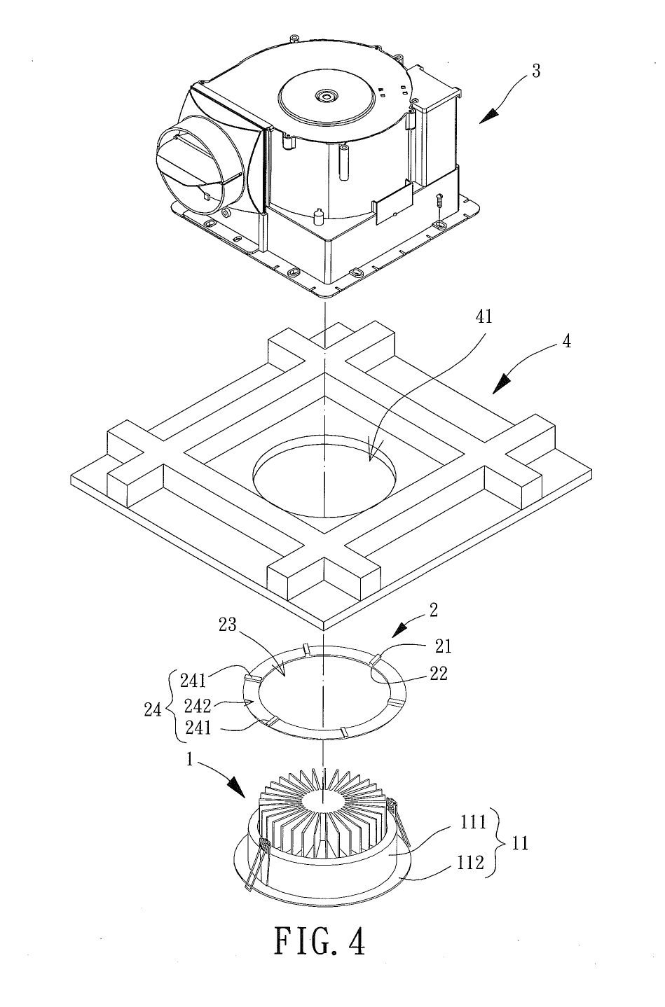

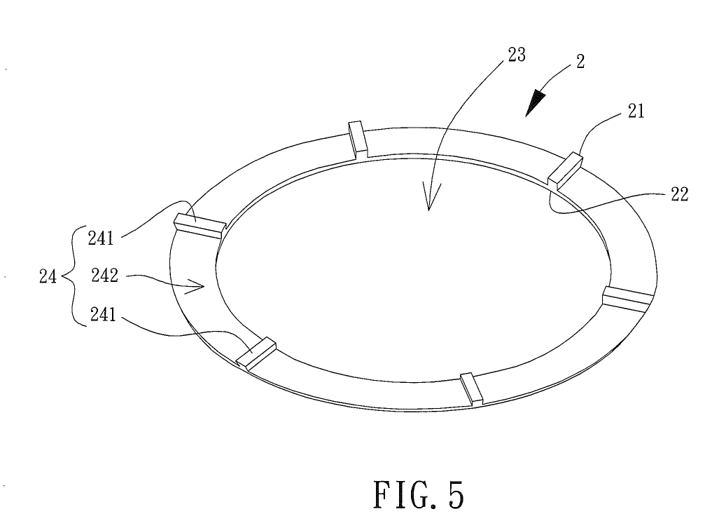

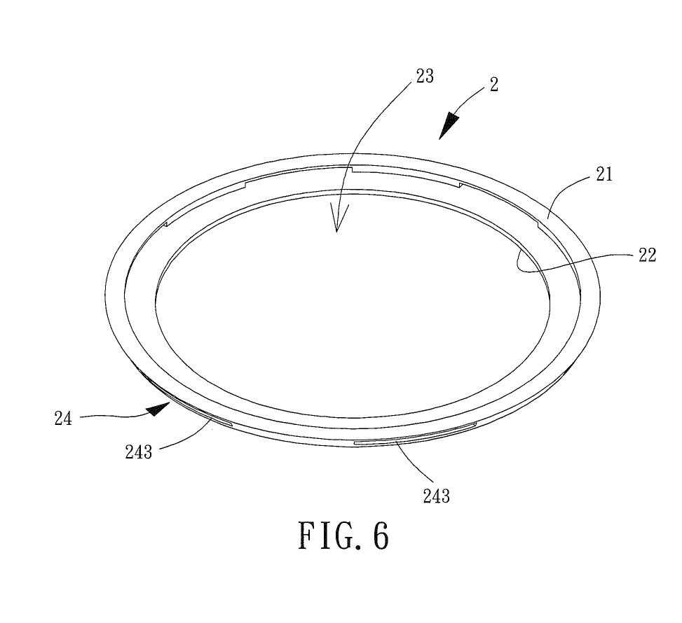

FIGS. 4 and 5 show a lamp including at least a lamp unit 1 and an air-guiding ring 2 according to an embodiment of the invention. Air-guiding ring 2 is fitted around lamp unit 1. In this embodiment, the lamp may include a fan 3 that is installed in a ceiling, a wall or other proper locations. In the embodiment shown in FIG. 4, the lamp may be installed in an installation hole 41 of a ceiling 4.

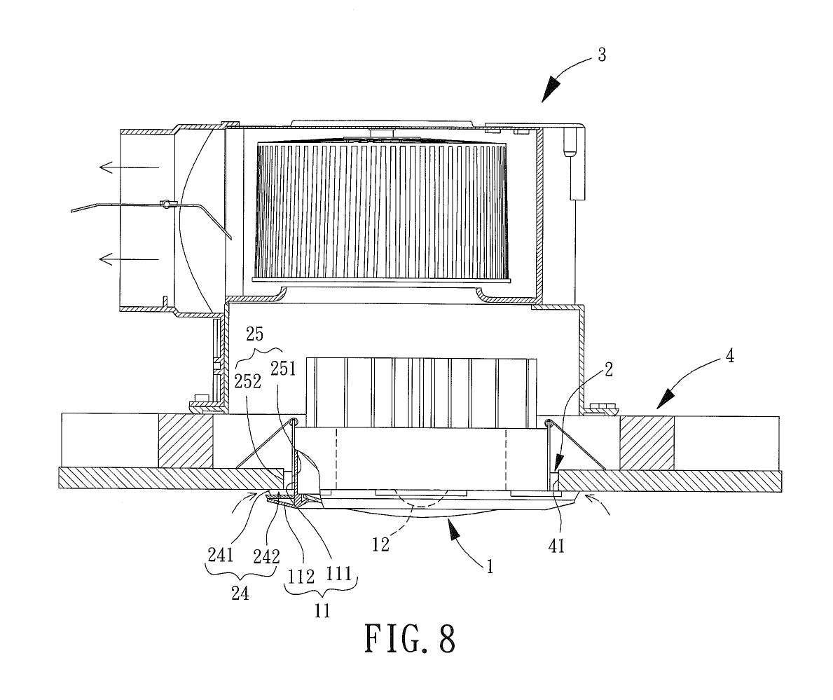

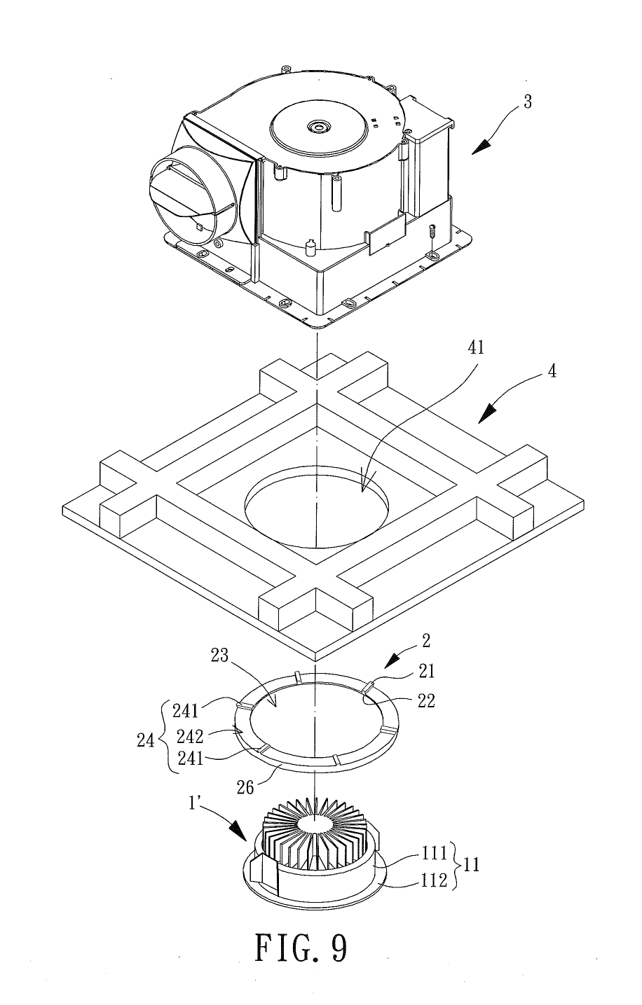

Lamp unit 1 includes a housing 11 receiving a light-emitting element 12 (as shown in FIG. 8) capable of emitting light. A fitted portion 111 is formed on an outer periphery of housing 11 in order to couple with air-guiding ring 2. Housing 11 may further include a decorative protrusion 112 adjoining the fitted portion 111, such that decorative protrusion 112 is able to cover air-guiding ring 2 when air-guiding ring 2 is fitted around lamp unit 1. Accordingly, a desired decorative function is provided.

Air-guiding ring 2 includes a first face 21 and a second face 22 opposite to first face 21. Air-guiding ring 2 includes an inner periphery forming a fitting hole 23 extending from first face 21 to second face 22. Air-guiding ring 2 can be fitted around the fitted portion 111 of lamp unit 1 via fitting hole 23. Air-guiding ring 2 may be preferably coupled with lamp unit 1 by loose fitting. Alternatively, air-guiding ring 2 may be coupled with lamp unit 1 by press fitting, adhesion, fastening, screwing or the like. The coupling mechanism between air-guiding ring 2 and lamp unit 1 is not limited to the above. Furthermore, air-guiding ring 2 further includes a venting portion 24 extending from an outer periphery to the inner periphery of air-guiding ring 2. Namely, venting portion 24 may extend from the outer periphery to fitting hole 23 of air-guiding ring 2.

Venting portion 24 of air-guiding ring 2 may be of any structure that extends from the outer periphery to the inner periphery of air-guiding ring 2. For example, venting portion 24 may be in the form of an opening or a slit that allows air to flow therethrough. In the embodiment of FIG. 5, air-guiding ring 2 may include a plurality of protrusions 241. The protrusions 241 are spaced from each other to form an opening 242 between two adjacent protrusions 241. Opening 242 extends from the outer periphery to the inner periphery of air-guiding ring 2. Alternatively, as shown in FIG. 6, venting portion 24 is in the form of a plurality of slits 243 extending from the outer periphery to the inner periphery of air-guiding ring 2.

Air-guiding ring 2 may be a plastic ring. Preferably, air-guiding ring 2 is a ring that can expand or shrink elastically (such as a rubber ring) so that air-guiding ring 2 can be easily fitted around the fitted portion 111 of housing 11 and enhance the coupling between air-guiding ring 2 and lamp unit 1.

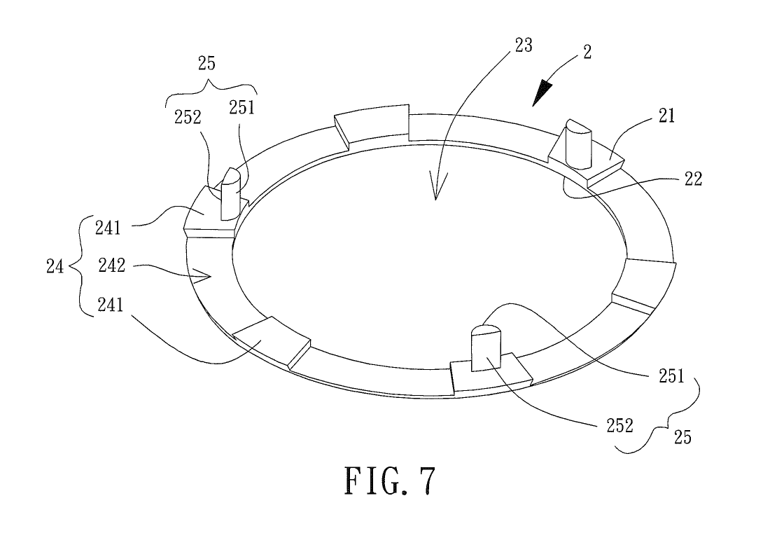

Referring to FIGS. 7 and 8, a plurality of positioning members 25 is preferably arranged on first face 21 of air-guiding ring 2. Each positioning member 25 includes an abutting face 251 and a coupling face 252 opposite to abutting face 251. Abutting face 251 may abut with the fitted portion 111 of housing 11. Coupling face 252 may abut with an inner periphery of ceiling 4 that forms installation hole 41. In addition, abutting face 251 is preferably in the form of an arc-like face in order not to scrape the surface of lamp unit 1 while lamp unit 1 is securely mounted in installation hole 41 of ceiling 4 via the plurality of positioning members 25.

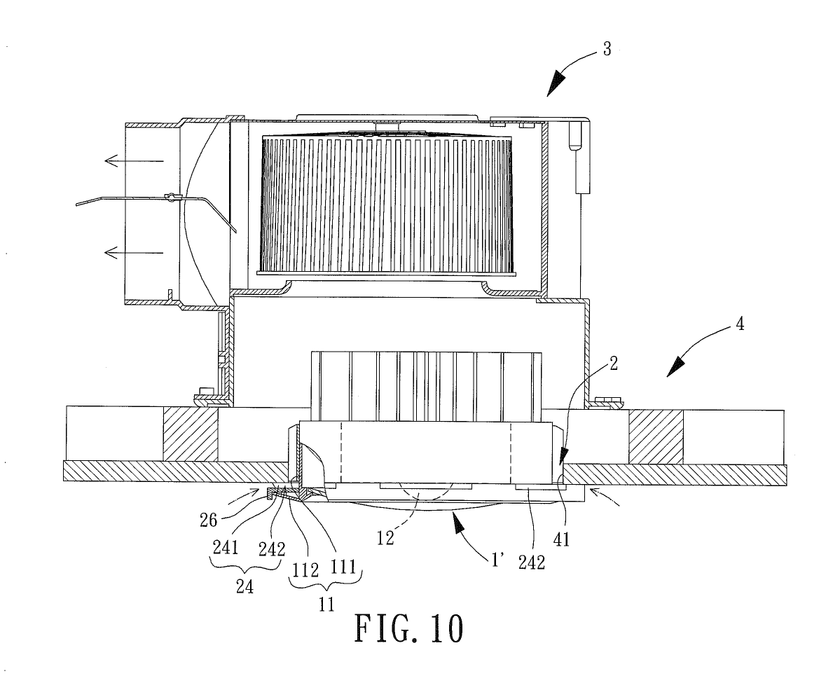

Lamp unit 1 may have different types of appearances or structures. FIGS. 9 and 10 show a lamp unit 1′ with another type of appearance or structure. Moreover, an outer cover 26 is preferably arranged on an outer periphery of air-guiding ring 2. Outer cover 26 extends in an axial direction perpendicular to the radial direction and can be used to cover an outer edge of decorative protrusion 112 for aesthetics when air-guiding ring 2 is fitted around the fitted portion 111 of lamp unit 1′.

Referring to FIGS. 8 and 10, during the use of the lamp, the lamp in the embodiment may be installed in a ceiling, a wall or other proper locations. For example, when the lamp is installed in ceiling 4, air-guiding ring 2 is fitted around the fitted portion 111 of lamp unit 1, 1′ and fixed to installation hole 41 of ceiling 4. Air-guiding ring 2 may be fixed to installation hole 41 of ceiling 4 by press fitting, adhesion, fastening or screwing. Since air-guiding ring 2 has venting portion 24, an air channel can be formed between venting portion 24 and ceiling 4 for the air to pass through. In this regard, when fan 3 is installed in ceiling 4 (fan 3 may be directly affixed to ceiling 4 or directly coupled with lamp unit 1, 1′), fan 3 is able to guide the air into and out of the lamp via venting portion 24. As such, the desired ventilation effect is provided while the heat generated during the operation of the lamp is expelled, thereby prolonging the service life of the lamp.

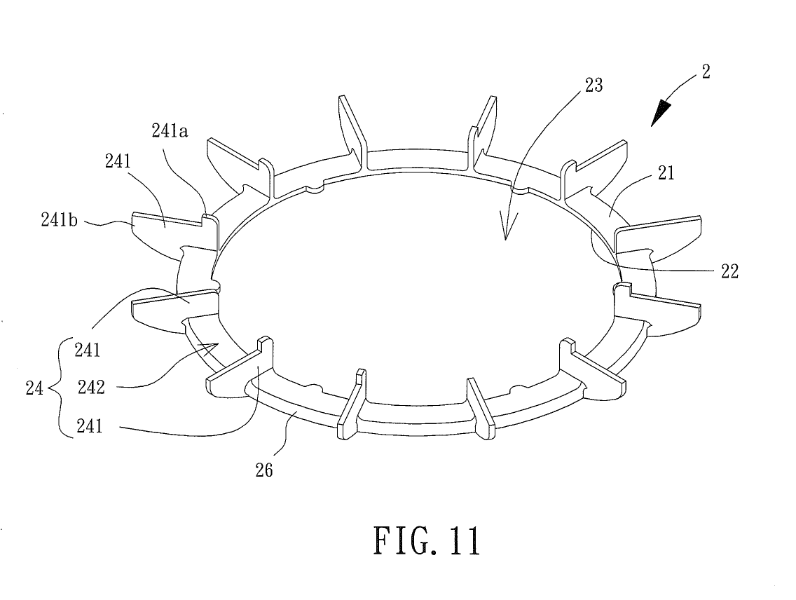

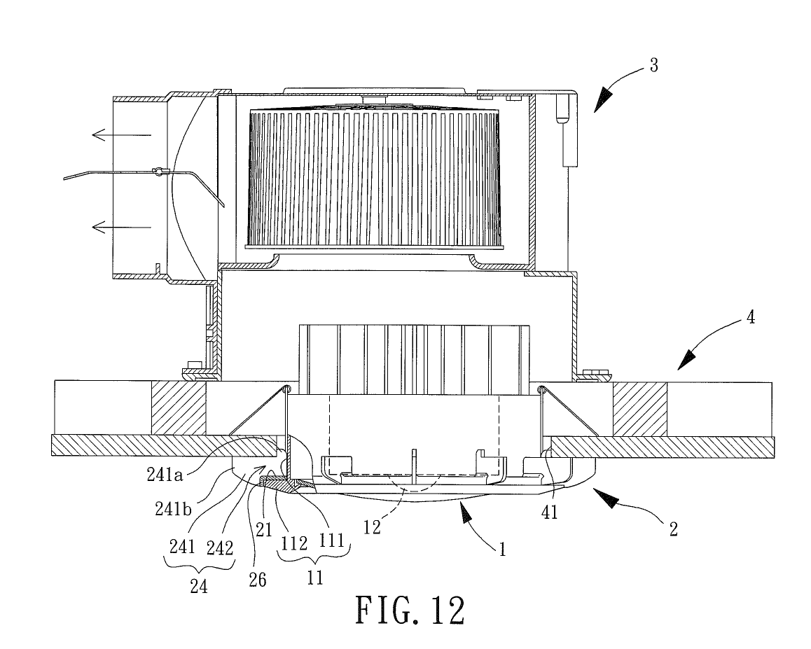

Referring to FIGS. 11 and 12, at least one of the plurality of protrusions 241 may include an abutting protrusion 241a adjacent to the inner periphery of air-guiding ring 2. In addition, at least one of the plurality of protrusions 241 may include a radial extension 241b extending outwards from the outer periphery of air-guiding ring 2 in a radial direction. In this arrangement, when lamp unit 1 is fixed at installation hole 41 of ceiling 4 via air-guiding ring 2, abutting protrusion 241a may couple with air-guiding ring 2 such that an edge of abutting protrusion 241a is adjacent to or aligned with the inner periphery of installation hole 41 of ceiling 4. Thus, an air channel may be formed between venting portion 24 and ceiling 4. Furthermore, radial extension 241b may increase the contact area between venting portion 24 and ceiling 4, and outer cover 26 may be coupled with decorative protrusion 112 of lamp unit 1 to effectively reinforce the coupling effect between air-guiding ring 2, ceiling 4 and lamp unit 1.

Based on the above structure of the lamp, air-guiding ring 2 can be easily fitted around lamp unit 1, 1′ before the lamp is installed in installation hole 41 of ceiling 4. Due to this property, the installation of the lamp does not require complex procedures, thus reducing the assembly complexity of the lamp.

Furthermore, since the lamp in the embodiment is able to directly form the air channel between venting portion 24 and ceiling 4 when installed in installation hole 41 of ceiling 4, fan 3 can provide the desired ventilation effect simply using the venting portion 24 without having to drill extra vents on ceiling 4 in addition to installation hole 41. Advantageously, convenient use and cost reduction are attained.

Furthermore, air-guiding ring 2 can also be directly fitted around other kind of lamp with suitable structure (such as a sleeve-like lamp) without changing the structures of modern lamps. In this regard, fan 3 may also be used to provide a ventilation effect for improved utility.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A lamp comprising:
a lamp unit having a housing, wherein the housing receives a light-emitting element, and a fitted portion is formed on an outer periphery of the housing; and
an air-guiding ring having an inner periphery forming a fitting hole, wherein the air-guiding ring is fitted around the fitted portion of the lamp unit via the fitting hole, wherein the air-guiding ring comprises a venting portion extending from an outer periphery to the inner periphery of the air-guiding ring.

2. The lamp as claimed in claim 1, wherein the venting portion is in a form of a plurality of openings, wherein a plurality of protrusions is formed on a face of the air-guiding ring, wherein the protrusions are spaced from each other to form a respective one of the plurality of openings between each two adjacent protrusions, and wherein the plurality of openings extends from the outer periphery to the inner periphery of the air-guiding ring.

3. The lamp as claimed in claim 1, wherein the venting portion is in a form of a plurality of slits extending from the outer periphery to the inner periphery of the air-guiding ring.

4. The lamp as claimed in claim 1, wherein the air-guiding ring is a ring with elastic expansion or shrinkage.

5. The lamp as claimed in claim 1, wherein a plurality of positioning members is arranged on a face of the air-guiding ring.

6. The lamp as claimed in claim 5, wherein each positioning member has an abutting face and a coupling face opposite to the abutting face, wherein the abutting face abuts with the fitted portion of the housing.

7. The lamp as claimed in claim 6, wherein the abutting face is an arc-like face.

8. The lamp as claimed in claim 1, wherein the lamp unit is coupled with a fan.

9. The lamp as claimed in claim 1, wherein the housing comprises a decorative protrusion adjoining the fitted portion and covering the air-guiding ring.

10. The lamp as claimed in claim 9, wherein an outer cover is arranged on the outer periphery of the air-guiding ring, and the outer cover is coupled with the decorative protrusion of the housing.

11. The lamp as claimed in claim 1, wherein an outer cover is arranged on the outer periphery of the air-guiding ring.

12. The lamp as claimed in claim 2, wherein at least one of the plurality of protrusions includes an abutting protrusion, the abutting protrusion is close to the inner periphery of the air-guiding ring than to the outer periphery of the air-guiding ring.

13. The lamp as claimed in claim 2, wherein at least one of the plurality of protrusions includes a radial extension extending outwards from the outer periphery of the air-guiding ring in a radial direction.

14. An air-guiding ring of a lamp having an inner periphery forming a fitting hole and a venting portion extending from an outer periphery to the inner periphery of the air-guiding ring.

15. The air-guiding ring of the lamp as claimed in claim 14, wherein the venting portion is in a form of a plurality of openings, wherein a plurality of protrusions is formed on a face of the air-guiding ring, wherein the protrusions are spaced from each other to form a respective one of the plurality of openings between each two adjacent protrusions, and wherein the plurality of openings extends from the outer periphery to the inner periphery of the air-guiding ring.

16. The air-guiding ring of the lamp as claimed in claim 14, wherein the venting portion is in a form of a plurality of slits extending from the outer periphery to the inner periphery of the air-guiding ring.

17. The air-guiding ring of the lamp as claimed in claim 14, wherein the air-guiding ring is a ring with elastic expansion or shrinkage.

18. The air-guiding ring of the lamp as claimed in claim 14, wherein a plurality of positioning members is arranged on a face of the air-guiding ring.

19. The air-guiding ring of the lamp as claimed in claim 18, wherein each positioning member has an abutting face and a coupling face opposite to the abutting face.

20. The air-guiding ring of the lamp as claimed in claim 19, wherein the abutting face is an arc-like face.

21. The air-guiding ring of the lamp as claimed in claim 14, wherein an outer cover is arranged on the outer periphery of the air-guiding ring.

22. The air-guiding ring of the lamp as claimed in claim 15, wherein at least one of the plurality of protrusions includes an abutting protrusion, the abutting protrusion is close to the inner periphery of the air-guiding ring than to the outer periphery of the air-guiding ring.

23. The air-guiding ring of the lamp as claimed in claim 15, wherein at least one of the plurality of protrusions includes a radial extension extending outwards from the outer periphery of the air-guiding ring in a radial direction.

24. The air-guiding ring of the lamp as claimed in claim 14, wherein an outer cover is arranged on the outer periphery of the air-guiding ring.
